(19) United States
(12) Patent Application Publication
(10) Pub. No.: US 2019/0242391 A1
(43) Pub. Date: Aug. 8, 2019

(54) CEILING FAN

(71) Applicant: TTI (MACAO COMMERCIAL OFFSHORE) LIMITED, Macau (MO)

(72) Inventors: J. Porter Whitmire, Greenville, SC (US); J. Luke Jenkins, Anderson, SC (US)

(21) Appl. No.: 16/266,493

(22) Filed: Feb. 4, 2019

Related U.S. Application Data
(60) Provisional application No. 62/627,434, filed on Feb. 7, 2018.

(51) Int. Cl. F04D 25/08; F04D 29/44; F04D 29/42; F04D 17/16; F04D 29/60; F21V 33/00

(52) U.S. Cl. CPC F04D 25/088; F04D 29/441; F04D 29/4253; F04D 17/165; F21W 2131/30; F21V 33/0096; F05B 2240/14; F05B 2240/123; F04D 29/601

(57) ABSTRACT

A ceiling fan may include a housing having a central longitudinal axis, an inlet, and an interior in fluid communication with the inlet. The ceiling fan may include a nozzle disposed around a portion of the housing that may be spaced a distance apart from the housing and define an interior passageway and an outlet in fluid communication with the interior passageway. The ceiling fan may include a conduit disposed between portions of the housing and the nozzle in fluid communication with the interior of the housing and the interior passageway of the nozzle. The fan may further include an impeller disposed in the housing and a motor coupled to the impeller. The motor may rotate the impeller for drawing air into the interior of the housing through the inlet, moving air through the conduit and the interior passageway, and expelling air out of the outlet in a preferential direction.

### CROSS REFERENCE TO RELATED APPLICATIONS

This application claims priority to U.S. Provisional Patent Application No. 62/627,434, filed Feb. 7, 2018, the entire contents of which are incorporated by reference herein.

### BACKGROUND

The present subject matter relates to ceiling fans, and in particular, to a bladeless ceiling fan.

Ceiling fans may be mounted to ceilings to circulate air within rooms. Some fans include blades or impellers positioned within a housing such that the blades or impellers are not visible to a user. Such fans are referred to as bladeless fans. A bladeless fan typically draws air in through an opening of the housing and guides the air through inner pathways until the air is pushed out of the inner pathways in a given direction. Taking advantage of the Bernoulli principle and Coanda effect, high velocity air expelled from the inner pathways draws additional air into the airflow zone, thereby increasing a total air flow.

### SUMMARY

In one embodiment, a ceiling fan may include a housing having a central longitudinal axis, an inlet, and an interior in fluid communication with the inlet. The ceiling fan may also include a nozzle disposed around a portion of the housing. The nozzle may be spaced a distance apart from the housing. The nozzle may define an interior passageway and an outlet in fluid communication with the interior passageway. The ceiling fan may also include a conduit disposed between portions of the housing and the nozzle. The conduit may be in fluid communication with the interior of the housing and the interior passageway of the nozzle. The fan may further include an impeller disposed in the housing and a motor coupled to the impeller. The motor may be configured to rotate the impeller for drawing air into the interior of the housing through the inlet, moving the air through the conduit and the interior passageway, and expelling the air out of the outlet in a preferential direction.

In another embodiment, a ceiling fan may include a housing defining a central longitudinal axis, an inlet, and an interior in fluid communication with the inlet. The ceiling fan may also include a nozzle having a center aligned with the central longitudinal axis. The nozzle may include an interior passageway, an outlet in fluid communication with the interior passageway, and a lower wall defining at least part of the interior passageway. A portion of the lower wall may form a light support surface. The ceiling fan may also include a conduit connecting the housing and the nozzle. The conduit may be in fluid communication with the interior of the housing and the interior passageway of the nozzle. The ceiling fan may further include an impeller disposed in the housing and a motor coupled to the impeller. The motor may be operable to rotate the impeller for drawing air into the interior of the housing through the inlet and expelling air out of the outlet of the nozzle. The ceiling fan may further include one or more lights supported by the light support surface of the nozzle.

In another embodiment, a ceiling fan may include a housing with an inlet, an interior in fluid communication with the inlet, a central longitudinal axis, and a first maximum outer width. The ceiling fan may also include a nozzle having a center aligned with the central longitudinal axis. The nozzle may be spaced apart from the housing in a direction parallel to the central longitudinal axis. The nozzle may include an interior passageway and an outlet in fluid communication with the interior passageway. The nozzle may have a second maximum outer width that is equal to or less than the first maximum outer width. The fan may also include a conduit extending between the housing and the nozzle. The conduit may be in fluid communication with the interior of the housing and the interior passageway of the nozzle. The ceiling fan may further include an impeller disposed in the interior of the housing and a motor disposed in the interior of the housing and coupled to the impeller. The motor may be operable to rotate the impeller to draw air into the interior of the housing through the inlet and expel air out of the outlet of the nozzle.

Other aspects of the present subject matter will become apparent by consideration of the detailed description and accompanying drawings.

### BRIEF DESCRIPTION OF THE DRAWINGS

FIG. 1 is a perspective view of a ceiling fan according to one embodiment of the present subject matter.

FIG. 2 is a top view of the ceiling fan of FIG. 1.

FIG. 3 is a cross sectional view of the ceiling fan of FIG. 2, taken along section line 3-3 of FIG. 2.

FIG. 4 is a perspective view of multiple ceiling fans being supported from a ceiling.

FIG. 5 is a perspective view of a ceiling fan according to another embodiment of the present subject matter.

FIG. 6 is a cross sectional view of the ceiling fan shown in FIG. 1 taken along section line 6-6 of FIG. 5.

FIG. 7 is a perspective view of multiple ceiling fans being supported from a ceiling.

Before any embodiments are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways.

### DETAILED DESCRIPTION

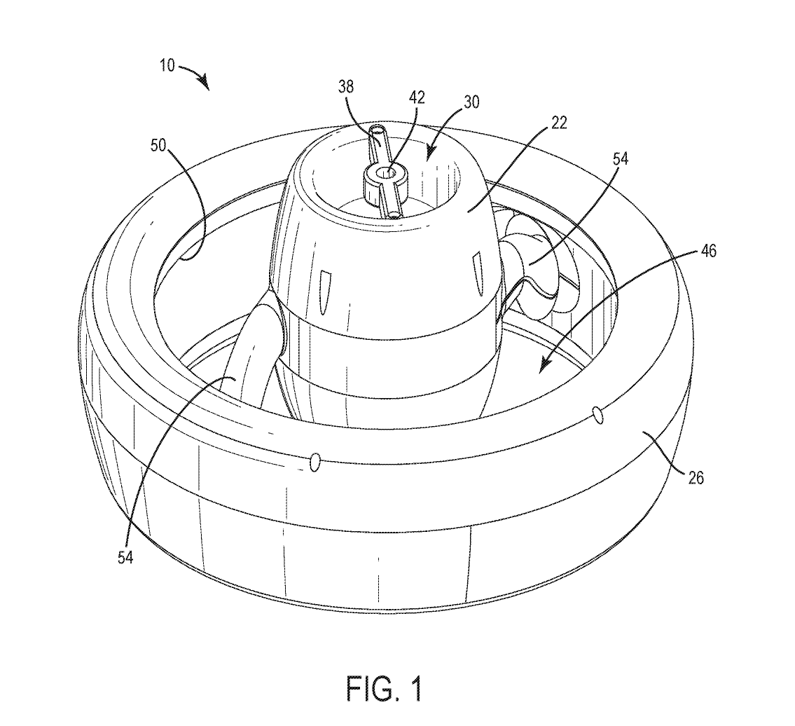

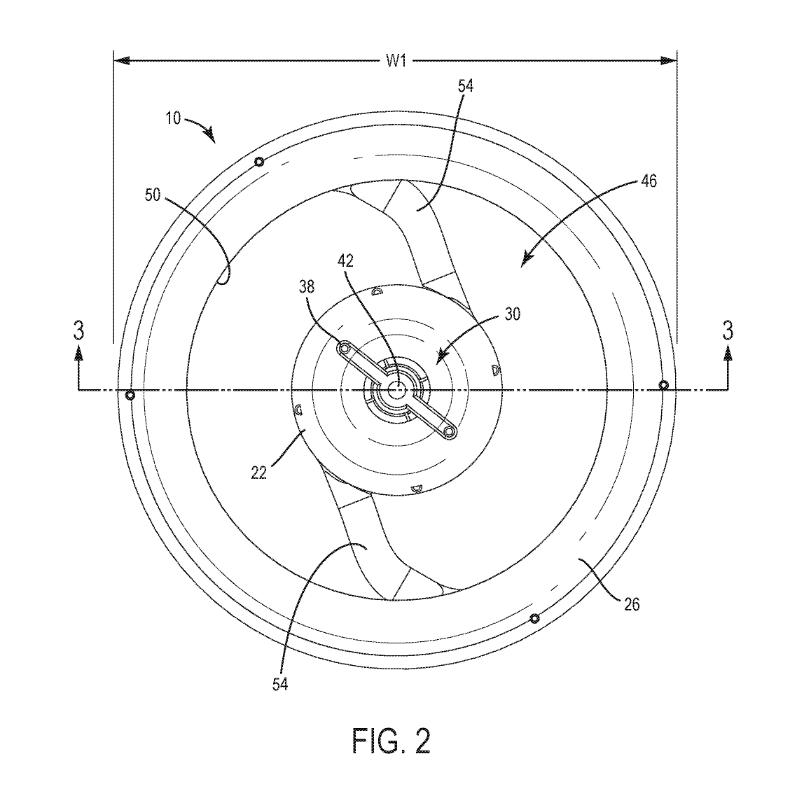

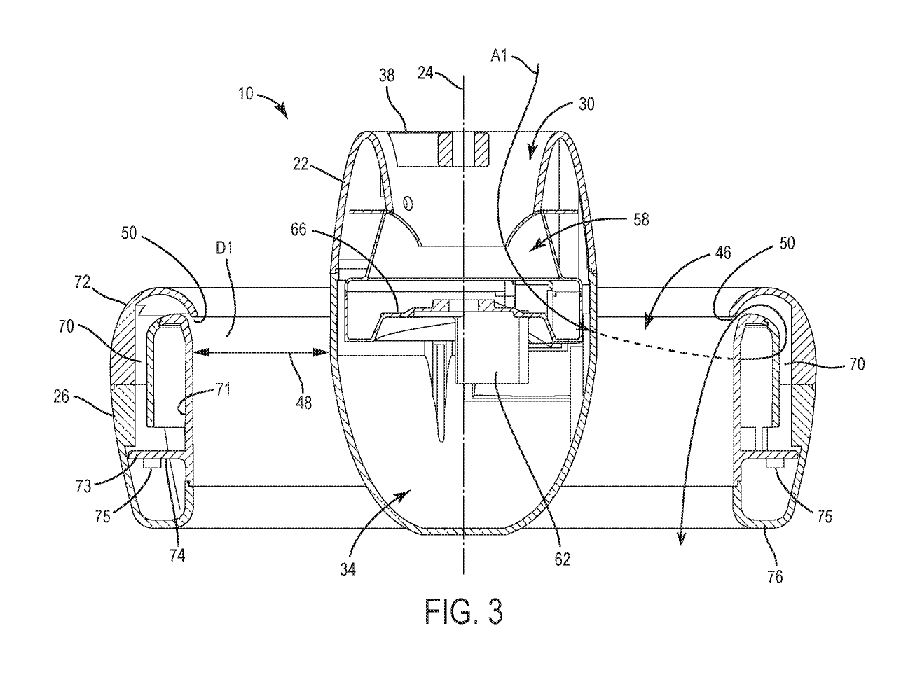

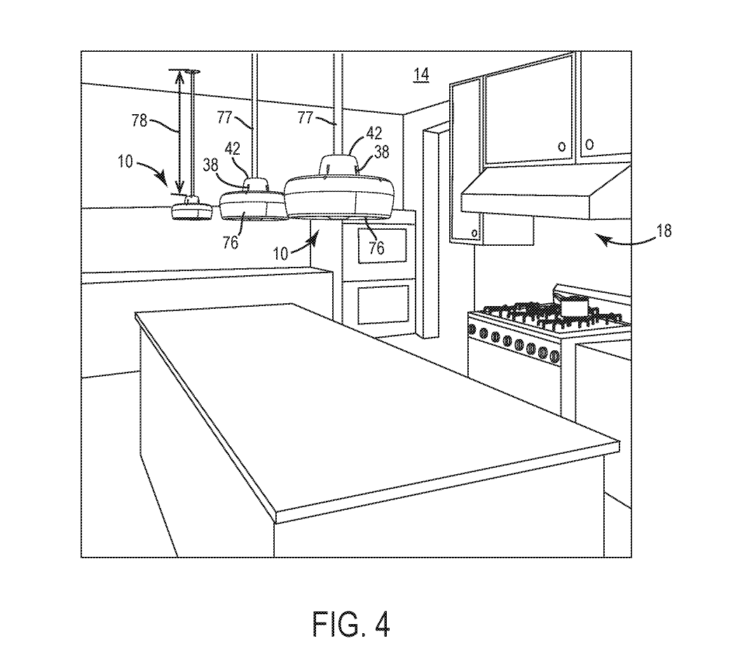

FIGS. 1-4 illustrate a ceiling fan, generally designated 10. In some embodiments, the ceiling fan 10 may be supported from a ceiling 14 (FIG. 4) of a room 18 (FIG. 4) for creating an airflow in the room 18. Now with reference to FIGS. 1-2, the ceiling fan 10 may include a housing 22 that is centrally disposed within and/or respective to a nozzle 26. The housing 22 may include an air inlet 30 that leads to an interior 34 (FIG. 3) of the housing 22, and the housing 22 may include a central longitudinal axis 24 (FIG. 3). A coupling member 38 may be provided on (e.g., formed on, mounted on, and/or the like) a first side of the housing 22, the first side of the housing 22 being more proximate to the ceiling 14 (FIG. 4). In some embodiments, the coupling member 22 may be configured to couple the ceiling fan 10 to the ceiling 14 (FIG. 4) and/or to couple the ceiling fan 10 to a support (e.g., a cable, a rope, a downrod, and/or the like) that extends from the ceiling 14 (FIG. 4). The coupling member 38 may extend at least partially over the air inlet 30, and may be mounted to the housing 22 with fasteners (e.g., screws, bolts, nails, and/or the like), in some embodiments. The coupling member 38 may include a coupling portion 42 that may be disposed co-axial with, or substantially co-axial with, the air inlet 30, and the coupling portion 42 may include a male coupling portion (e.g., a threaded or non-threaded stem, rod, and/or the like), a female coupling portion (e.g., a threaded or non-threaded receptacle, aperture, and/or the like), and/or the like for coupling the ceiling fan 10 to an object or surface as described herein.

With continued reference to FIGS. 1-2, the illustrated nozzle 26 may include an annular (e.g., an annularly shaped) nozzle having a circular shape, or a substantially circular shape. In other embodiments, the nozzle 26 may have other suitable shapes that may be non-circular, such as a square shape, a rectangular shape, a hexagonal shape, an oval shape, an oblong shape, a symmetric shape (e.g., symmetric respective to axis 24), an asymmetric shape (e.g., asymmetric respective to axis 24), and/or the like. The nozzle 26 may be disposed around portions of the housing 22, in some embodiments. That is, a center of the nozzle 26 may be aligned with (e.g., concentric with) the housing 22, and the housing 22 may be at least partially nested within the nozzle 26, in some embodiments. The ceiling fan 10, thereby, may define an opening 46 or space (e.g., a gap) disposed between the nozzle 26 and the housing 22. The opening 46 may be an open space formed between the nozzle 26 and the housing 22. The opening 46 may define a distance 48 (FIG. 3) in a direction perpendicular to the axis 24, in which the housing 22 is spaced apart from the nozzle 26. In some embodiments, the distance 48 may be less than a maximum diameter or width W1 (FIG. 2) of the ceiling fan 10 (e.g., the diameter of the nozzle 26). In other embodiments, the distance 48 may be less than half the width W1, less than a third of the width W1, less than a fourth of the width W1, and/or otherwise smaller than the width W1. In further embodiments, the distance 48 may be greater than two inches, greater than 3 inches, and/or greater than 4 inches. The distance 48 may be uniform about the axis 24 or the distance 48 between the nozzle 26 and the housing 22 may vary about the axis 24. The nozzle 26 may also include an annular (e.g., an annularly shaped) outlet 50 that extends around an inner perimeter of the nozzle 26. One or more conduits (e.g., arms 54) may provide a physical and/or fluid connection between the housing 22 and the nozzle 26. In the illustrated embodiment, the ceiling fan 10 may include two arms 54. In other embodiments, the ceiling fan 10 may include one arm 54 or more than two arms 54. Each arm 54 may include and/or define an air passageway (not shown in this embodiment) that allows the housing 22 to be in fluid communication with the nozzle 26. In this way, each arm 54 may be configured to provide a rigid, mechanical support for supporting the nozzle 26 respective to the housing 22 and additionally provide a conduit therebetween, thus, improving (e.g., optimizing, increasing, and/or the like) a volume and/or a velocity of the airflow being expelled by ceiling fan 10. The arms 54 may be non-linear (e.g., curvilinear, curved, sloped, partially helically shaped), in some embodiments.

With reference now to FIG. 3, the interior 34 of the housing 22 may include an air chamber 58 through which air from the air inlet 30 may be caused to enter into. The air chamber 58 may be configured to receive, house, and/or support a motor 62 and/or an impeller 66. The motor 62 may be electrically coupled to a power source (not shown) and the impeller 66 may be driven by the motor 62 for rotation within the air chamber 58 to induce an airflow through the ceiling fan 10. The impeller 66 may rotate about (e.g., respective to) the central longitudinal axis 24.

With continued reference to FIG. 3, an annularly shaped passageway 70 may be defined between walls of the nozzle 26. Specifically, the passageway 70 may be defined by and/or between an inner first wall 71, an outer second wall 72, and a lower wall 73 connecting the first wall 71 and the second wall 72. The passageway 70 may be formed as an interior passageway that is configured to receiving an airflow transferred thereto by way of conduits disposed in the one or more arms 54 (FIGS. 1-2). In some embodiments, an end of the second wall 72 may at least partially overlap an end of the first wall 71 to define the outlet 50 from which air may be expelled from the ceiling fan 10. As such, the outlet 50 may be defined by and/or between the first and second walls 71, 72. In the illustrated embodiment, the outlet 50 may be located closer to an upper side of the nozzle 26 than a lower side of the nozzle 26. In other embodiments, the outlet 50 may be located elsewhere on or over the nozzle 26.

As shown in the illustrated embodiment, a portion of the lower wall 73 may include and/or form a light support surface 74 being configured to support a plurality of lights 75. For example, an exterior portion (e.g., an exterior face) of the lower wall 73 may form the light support surface 74. In some embodiments, only one light 75 may be provided on or over the light support surface 74. In some embodiments, the lights 75 may be mounted to the housing 22 or other parts of the ceiling fan 10. The lights 75 may include light bulbs (e.g., incandescent bulbs, LED bulbs, and/or the like); however, other types of lights and/or lighting sources forming the lights 75 (e.g., LED lighting sources, incandescent lighting sources, fluorescent lighting sources, and/or the like) are contemplated. In the illustrated embodiments, the lights 75 may be spaced circumferentially along or around the lower wall 73. In some embodiments, the lights 75 may be spaced evenly about the lower wall 73, although in other embodiments, the lights 75 may be spaced unevenly about the lower wall 73. In some embodiments, the lower wall 73 may be formed from a suitable material (e.g., aluminum, a thermally conducting plastic, and/or the like) to provide a heat sink. A light cover 76 may be coupled to the nozzle 26 over the lower wall 73. The light cover 76 may include a lens configured to protect the lights 75 and/or a cover configured to diffuse, reflect, and/or guide the light being emitted by the lights 75.

The nozzle 26 may further include a diffuser surface D1 on an opposite side of the first wall 71 than the passageway 70. The diffuser surface D1 may direct or guide air being expelled from the outlet 50. As such, air may cling to the diffuser surface D1 as the air passes the nozzle 26 to control aspects of the air and/or aim the air in a particular direction. The diffuser surface D1 may be substantially linear, smooth, curved, rough, and/or the like to better guide the air.

Still referring to FIG. 3, and in some embodiments, the passageway 70 may be in fluid communication with the passageways formed by the arms 54, and the passageways formed by the arms 54 may be in fluid communication with the air chamber 58 of the interior 34 of the housing 22. In other words, the air inlet 30, the air chamber 58 of the interior 34 of the housing 22, the passageways within the arms 54, and the passageway 70 of the nozzle 26 may all be in fluid communication for forming a continuous airflow path A1, or a substantially continuous airflow path A1, through the ceiling fan 10. The airflow path A1 may extend through the air inlet 30 and into the air chamber 58. From the air chamber 58, the airflow path A1 may enter one of the passageways of the arms 54 and into the passageway 70 of the nozzle 26. The airflow path A1 may then be expelled from the outlet 50.

During operation of the ceiling fan 10, the motor 62 may rotate the impeller 66 to draw air from outside the ceiling fan 10 into the ceiling fan 10 by way of the air inlet 30 and the air chamber 58. The impeller 66 may continue to propel the air through the passageways of the arms 54 and into the passageway 70 of the nozzle 26. Air pressure may begin to build within the passageway 70 as more air is driven or pushed into the passageway 70. Once the air pressure is high enough, the air may continually be expelled from the outlet 50 in a downwards direction as viewed from FIG. 3 over the diffuser surface D1. Due to the high air pressure, the air may be expelled at a high velocity, drawing air surrounding the ceiling fan 10 through the opening 46 for creating an amplified airflow effect.

Providing a housing 22 that may be spaced a distance 48 from a nozzle 26 allows for additional air to be drawn through a central opening 46 defined by the nozzle 26, creating an amplifying effect. Additionally, providing a diffuser surface D1 that air clings to while being expelled from an outlet 50 of a fan 10 may allow the amplified air to be directed in a preferential direction. The preferential direction may be any direction. In some embodiments, the preferential direction may be substantially parallel to the central longitudinal axis 24, perpendicular to the central longitudinal axis 24, and/or oblique to the central longitudinal axis 24.

With reference now to FIG. 4, the ceiling fan 10 may be hung from a ceiling 14 of a room 18 (e.g., kitchen, a living room, a family room, a bathroom, an office, and/or the like) by a support 77. In some embodiments, the support 77 may be a relatively flexible structure, such as a rope or cable. In other embodiments, the support 77 may be a relatively rigid structure, such as a downrod. The support 77 may be configured to support the weight of the ceiling fan 10 and also guide or direct wiring to the ceiling fan 10 to power the motor 62 and/or the lights 75. The support 77 may couple with the coupling portion 42 (FIG. 1) of the coupling member 38 (FIG. 1). The support 77 may include a length 78 by which the ceiling fan 10 may be suspended from and/or hang a distance below the ceiling 14 to create an aesthetically pleasing look, to create a desired airflow, and/or to create a desired light output. The length 78 may be greater than the maximum diameter or width W1 (FIG. 2) of the ceiling fan 10 (e.g., the diameter of the nozzle 26), in some embodiments. In the illustrated embodiment, the length 78 may include a relatively long distance compared to the width W1 or diameter of the ceiling fan 10, giving the ceiling fan 10 a pendant-type appearance. In this way, a user may select and/or customize a distance by which to hang the ceiling fan 10 and/or position the lights (e.g., 75, FIG. 3) of the ceiling fan 10 relative to a surface below for a desired effect. For example, the length 78 may be at least twice as large as the maximum width W1. More particularly, the length 78 may be two times, three times, four times, five times, ten times, or more than the maximum width W1 or diameter of the ceiling fan 10. As shown in FIG. 4, multiple ceiling fans 10 may be supported from the ceiling 14.

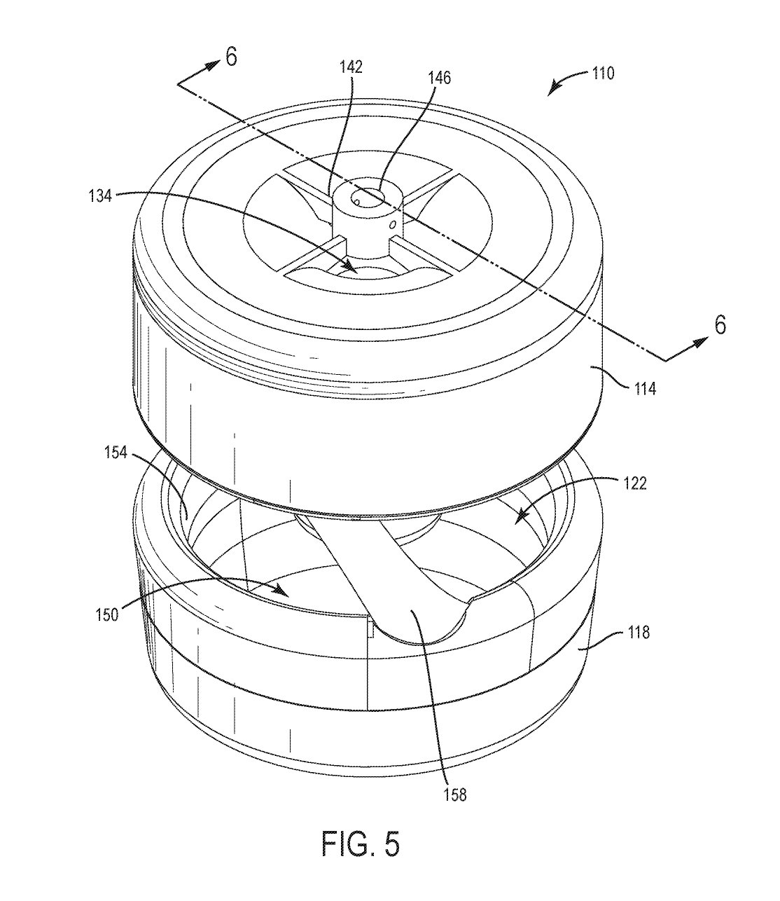

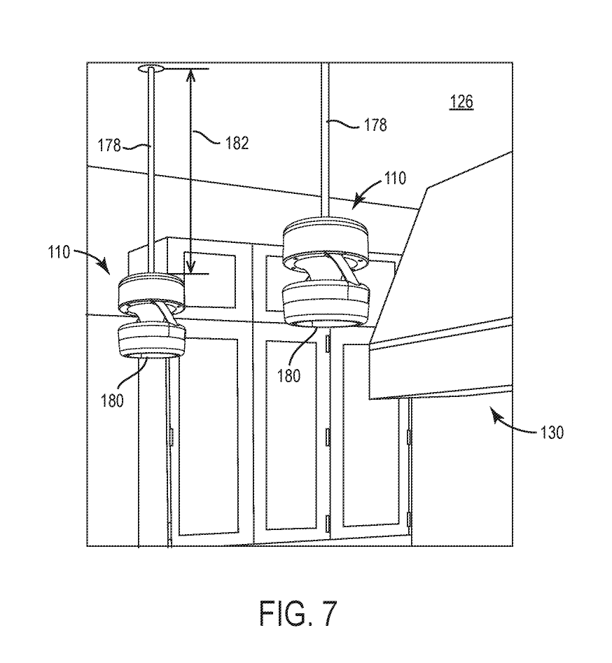

FIGS. 5-7 illustrate another ceiling fan, generally designated 110. The ceiling fan 110 may be similar to the ceiling fan 10, but may include a housing 114 disposed more proximal from a ceiling 120 (FIG. 7) and a nozzle 118 disposed more distal from the ceiling 120 (FIG. 7). A gap 122 may be disposed or formed between the housing 114 and the nozzle 118. The ceiling fan 110 may be supported from the ceiling 120 of a room 130 (FIG. 7) to create an airflow in the room 130.

Similar to the nozzle 26 described above, the illustrated nozzle 118 may be include an annularly shaped nozzle having a circular or a non-circular shape. In other embodiments, the nozzle 118 may have other suitable shapes, such as square, rectangular, hexagonal, oval, oblong, and the like

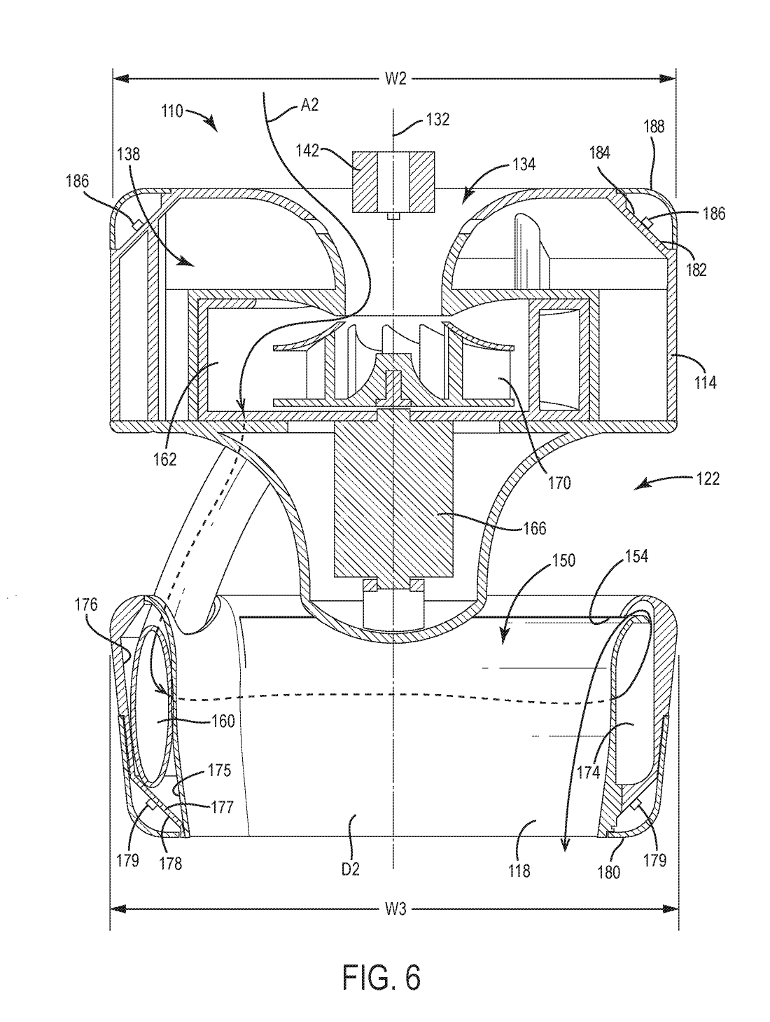

With reference to FIG. 6, the housing 114 may include a central longitudinal axis 132 and an air inlet 134 that leads to an interior 138 of the housing 114. The housing 114 may define a first maximum outer width W2 (e.g., diameter). Moving to FIG. 5, a coupling member 142 (e.g., a bracket, rod, threaded connector, and/or the like) may be mounted to a top side of the housing 114 and may extend over the air inlet 134. The coupling member 142 may be mounted to the housing 114 with fasteners (e.g., screws, bolts, nails, and/or the like). In some embodiments, the coupling member 142 may be integrally formed with the housing 114. The coupling member 142 may include a coupling portion 146 (e.g., a support receptacle, aperture, and/or the like) that may be co-axial with the air inlet 134.

Referring to FIGS. 5-6, the nozzle 118 may be spaced apart from the housing 114 in a direction parallel to the central longitudinal axis 132. As such, a center of the nozzle 118 may be aligned (e.g., concentric) with the central longitudinal axis 132 of the housing 114. The nozzle 118 may define a second maximum outer width W3 (e.g., diameter). As shown in the illustrated embodiment, the second maximum outer width W3 of the nozzle 118 may be equal, or approximately equal, to the first maximum outer width W2 of the housing 114. In some embodiments, the second maximum outer width W3 may be less than the first maximum outer width W2. In either scenario, the nozzle 118 may be within a space defined by the first maximum outer diameter W2 of the housing 22 in a direction parallel to the axis 132. In further embodiments, the second maximum outer width W3 may be greater than the first maximum outer width W2.

The nozzle 118 may define a central opening 150. The nozzle 118 may be spaced from the housing 114 such that none of the housing 114, or only a small part of the housing 114, is positioned within the central opening 150. The nozzle 118 may also include an annularly shaped outlet 154 that extends around an inner perimeter of the nozzle 118. One or more conduits (e.g., arms 158) may extend downwards from the housing 114 towards the nozzle 118 to connect the housing 114 and the nozzle 118. In the illustrated embodiment, the ceiling fan 110 may include two arms 158. In other embodiments, the ceiling fan 10 may include one arm 158 or more than two arms 158. Each arm 158 may include or define an air passageway 160 or conduit that allows the housing 114 to be in fluid communication with the nozzle 118.

With reference to FIG. 6, the interior 138 of the housing 114 may include an air chamber 162 into which air from the air inlet 134 enters. The air chamber 162 may include a motor 166 that may be electrically coupled to a power source (not shown) within the room 130 (FIG. 7) and an impeller 170 that may be driven by the motor 166 for rotation within the air chamber 162 to induce an airflow. The impeller 170 may rotate about the central longitudinal axis 132.

With continued reference to FIG. 6, an annularly shaped interior passageway 174 may be defined between the walls of the nozzle 118. Specifically, the passageway 174 may be defined between an inner first wall 175, an outer second wall 176, and a lower wall 177 extending therebetween. An end of the second wall 176 may partially overlap an end of the first wall 175 to define an annularly shaped outlet 154. As such, the outlet 154 may be defined between the first and second walls 175, 176. In the illustrated embodiment, the outlet 154 may be located more proximate to an upper side of the nozzle 118 (e.g., the side adjacent the housing 114) than a lower side of the nozzle 118. In other embodiments, the outlet 154 may be located elsewhere on the nozzle 118.

As shown in the illustrated embodiment, the lower wall 177 may include or define a light support surface 178 that supports a plurality of lights 179. For example, an exterior portion (e.g., an exterior face) of the lower wall 177 may form the light support surface 178. In some embodiments, only one light 179 may be provided on the light support surface 178. The lights 179 may include light bulbs (e.g., incandescent bulbs, LED bulbs, and/or the like); however, other types of lights and/or lighting sources forming the lights (e.g., LED lighting sources, incandescent lighting sources, fluorescent lighting sources, and/or the like) are contemplated. In the illustrated embodiments, the lights 179 may be spaced circumferentially along the lower wall 177. In some embodiments, the lights 179 may be spaced at equal, or substantially equal, increments around the lower wall 177, although in other embodiments, the lights 179 may be spaced at unequal increments around the lower wall 177. The lower wall 177 may be made of a suitable material (e.g., a thermally conductive material) to form a heat sink. A light cover 180 may be coupled to the nozzle 118 over the lower wall 177. The light cover 180 may include a lens configured to protect the lights 179 and/or diffuse, reflect, and/or guide the light being emitted by the lights 179.

The nozzle 118 may further include a diffuser surface D2 on an opposite side of the first wall 175 than the passageway 174. The diffuser surface D2 may direct or guide air being expelled from the outlet 154. As such, air may cling to the diffuser surface D2 as the air passes over the nozzle 118 to control aspects of the air and/or aim the air in a particular direction. The diffuser surface D2 may be curved to aim air in a preferential direction, such as in a direction downwards towards a center of the central opening 150. The preferential direction may be any direction. In some embodiments, the preferential direction may be substantially parallel to the central longitudinal axis 132, perpendicular to the central longitudinal axis 132, and/or oblique to the central longitudinal axis 132. In other embodiments, the diffuser surface D2 may be substantially linear, smooth, rough, and/or the like to better guide the air.

Still referring to FIG. 6, and in some embodiments, an upper wall 182 of the housing 114 that partially defines the interior 138 may include a light support surface 184. The light support surface 184 may support a plurality of lights 186 configured to direct light upward from the ceiling fan 110 (e.g., towards the ceiling). In some embodiments, only one light 186 may be provided on the light support surface 184. The lights 186 may include light bulbs (e.g., incandescent bulbs, LED bulbs, and/or the like); however, other types of lights and/or lighting sources forming the lights (e.g., LED lighting sources, incandescent lighting sources, fluorescent lighting sources, and/or the like) are contemplated. In the illustrated embodiments, the lights 186 may be spaced circumferentially along the upper wall 182. In some embodiments, the lights 186 may be spaced evenly about the upper wall 182, although in other embodiments, the lights 186 may be spaced unevenly about the upper wall 182. The upper wall 182 may form a heat sink. A light cover 188 may be coupled to the housing 114 over the upper wall 182. The light cover 188 may include a protective cover, a light diffusing cover, a light reflecting cover, a light guiding cover, and/or the like.

The passageway 174 may form an interior passageway of the nozzle 118 and be in fluid communication with the passageways of the arms 158, and the passageways of the arms 158 may be in fluid communication with the air chamber 162 of the interior 138 of the housing 114. In other words, the air inlet 134, the air chamber 162 of the interior 138 of the housing 114, the passageways 160 within the arms 158, and the annular passageway 174 of the nozzle 118 may all be in fluid communication. In this way, airflow through the ceiling fan 110 may be guided along a continuous airflow path A2, or a substantially continuous airflow path A2, through the ceiling fan 110. The airflow path A2 may extend through the air inlet 134 and into and/or around the air chamber 162. From the air chamber 162, the airflow path A2 may extend into one of the passageways 160 of the arms 158 and down from the housing 114 into the passageway 174 of the nozzle 118. The airflow path A2 may then flow around the passageway 17 before being expelled from the outlet 154. In this way, air passing over the upper and lower walls 177, 182 may additionally provide convective cooling to the lights 179, 186 on the light support surfaces 178, 184.

During operation of the ceiling fan 110, the motor 166 may rotate the impeller 170 to draw air from outside the ceiling fan 10 through the air inlet 134 and into the air chamber 162. The impeller 170 may continue to propel the air through the passageway of the arms 158 and into the passageway 174 of the nozzle 118. Air pressure may begin to build within the passageway 174 as more air is pushed into the passageway 174. Once the air pressure is high enough, air may be continually expelled from the outlet 154 in a direction downwards, as viewed from FIG. 6. Due to the high air pressure, the air may be expelled at a high velocity, drawing air surrounding the ceiling fan 110 through the opening 122 and through the central opening 150 and creating an amplified airflow effect.

With reference now to FIG. 7, the ceiling fan 110 may be hung from the ceiling 126 of the room 130 (e.g., kitchen, living room, family room, bathroom, and/or the like) by way of a support 190. In some embodiments, the support 190 may be a relatively flexible or inflexible structure as described above. The support 190 may be configured to support the weight of the ceiling fan 110 and also guide or direct wiring to the ceiling fan 110 to power the motor 166 and/or the lights 179, 186. The support 190 may couple to the coupling portion 146 of the coupling member 142 to hang the ceiling fan 110. The support 190 may include a length 192 to hang the ceiling fan 110 a distance below the ceiling 126 to create an aesthetically pleasing look. Similar to the ceiling fan 10 described above, the length 192 may be greater than the width W2 of the housing 114 and/or the width W3 of the nozzle 118. In the illustrated embodiment, the length 192 may be a relatively long distance compared to the width W2 of the housing 114 and/or the width W3 of the nozzle 118, giving the ceiling fan 110 a pendant-type appearance. As shown in FIG. 7, multiple ceiling fans 110 may be supported from a same ceiling 126.

In this way, ceiling fans 10, 110 having a support coupling member 38, 142 and a coupling portion 42, 146 that couples to support 77, 181 allows the ceiling fans 10, 110 to be suspended in way that benefits the interior design of a room. The ceiling fans 10, 110 also provide a greater airflow based on creating an amplifying effect.

Various features and advantages of the present subject matter are set forth in the following claims.

What is claimed is:

1. A ceiling fan comprising:
a housing having a central longitudinal axis, the housing including:
an inlet, and
an interior in fluid communication with the inlet;
a nozzle disposed around a portion of the housing,
the nozzle being spaced a distance apart from the housing, and
the nozzle defining an interior passageway and an outlet in fluid communication with the interior passageway;
a conduit disposed between portions of the housing and the nozzle,
the conduit being in fluid communication with the interior of the housing and the interior passageway of the nozzle;
an impeller disposed in the housing; and
a motor coupled to the impeller,
the motor being configured to rotate the impeller for drawing air into the interior of the housing through the inlet, moving the air through the conduit and the interior passageway, and expelling the air out of the outlet in a preferential direction.

2. The ceiling fan of claim 1, further comprising a coupling member configured to couple the fan to a support, the support having a length that is greater than a maximum outer width of the nozzle.

3. The ceiling fan of claim 2, wherein the support is a relatively flexible structure.

4. The ceiling fan of claim 2, wherein the support is a relatively rigid structure.

5. The ceiling fan of claim 2, wherein the length of the support is at least twice the maximum outer diameter of the annular nozzle.

6. The ceiling fan of claim 1, wherein the impeller is disposed in the interior of the housing.

7. The ceiling fan of claim 6, wherein the motor is disposed in the interior of the housing.

8. The ceiling fan of claim 1, wherein the nozzle comprises an annular shape.

9. The ceiling fan of claim 1, wherein the interior passageway comprises an annular shape.

10. The ceiling fan of claim 1, wherein the outlet is disposed on an inner perimeter of the nozzle.

11. The ceiling fan of claim 1, further comprising one or more lights being supported by a portion of the nozzle.

12. The ceiling fan of claim 11, wherein the distance is greater than about 2 inches.

13. The ceiling fan of claim 11, wherein the conduit is non-linear.

14. The ceiling fan of claim 13, wherein the preferential direction is substantially parallel to the central longitudinal axis.

15. A ceiling fan comprising:
a housing defining a central longitudinal axis, the housing including:
an inlet, and
an interior in fluid communication with the inlet;
a nozzle having a center aligned with the central longitudinal axis, the nozzle including:
an interior passageway,
an outlet in fluid communication with the interior passageway, and
a lower wall defining at least part of the interior passageway,
a portion of the lower wall forming a light support surface;
a conduit connecting the housing and the nozzle,
the conduit being in fluid communication with the interior of the housing and the interior passageway of the nozzle;
an impeller disposed in the housing;
a motor coupled to the impeller,
the motor being operable to rotate the impeller for drawing air into the interior of the housing through the inlet and expelling air out of the outlet of the nozzle; and
one or more lights being supported by the light support surface of the nozzle.

16. The ceiling fan of claim 15, further comprising a light cover disposed over the one or more lights.

17. The ceiling fan of claim 16, wherein the light cover is a light diffusing cover, a light reflecting cover, or a light guiding cover.

18. The ceiling fan of claim 15, wherein the one or more lights include one or more LEDs.

19. A ceiling fan comprising:
a housing including:
an inlet,
an interior in fluid communication with the inlet, and
the housing having a central longitudinal axis and a first maximum outer width;
a nozzle having a center aligned with the central longitudinal axis,
the nozzle being spaced apart from the housing in a direction parallel to the central longitudinal axis,
the nozzle including an interior passageway and an outlet in fluid communication with the interior passageway, and
the nozzle having a second maximum outer width that is equal to or less than the first maximum outer width;
a conduit extending between the housing and the nozzle,
the conduit being in fluid communication with the interior of the housing and the interior passageway of the nozzle;
an impeller disposed in the interior of the housing; and
a motor disposed in the interior of the housing and coupled to the impeller,
the motor being operable to rotate the impeller to draw air into the interior of the housing through the inlet and expel air out of the outlet of the nozzle.

20. The ceiling fan of claim 19, wherein a gap is defined between the nozzle and the housing.
